(19) United States
(12) Patent Application Publication
(10) Pub. No.: US 2004/0208297 A1
(43) Pub. Date: Oct. 21, 2004

(54) Call handling systems and methods

(76) Inventor: Miles Jefcoate Valentine, Orakei (NZ)

Correspondence Address: BROOKS KUSHMAN P.C., 1000 TOWN CENTER, TWENTY-SECOND FLOOR, SOUTHFIELD, MI, 48075, US

(21) Appl. No.: 10/475,385

(22) PCT Filed: Apr. 19, 2002
(86) PCT No.: PCT/NZ02/00065

(30) Foreign Application Priority Data
Apr. 19, 2001 (NZ) 511180

(51) Int. Cl. H04M 1/64

(52) U.S. Cl. 379/88.19; 379/67.1

(57) ABSTRACT

A call handling method and system as disclosed for handling telephone calls, particularly over wireless communication systems. The method provides for caller profiles (3) to be generated and matched to callers based on CNI (2) or ANI (2) information. The profiles (3) have one or more greetings which may be specifically provided for that or those callers. Profiles may also have commands (4) attached to them which allow the caller(s) associated with that profile to have unique specific options, for example having the user paged or calling a DID number. The commands also allow various other features of the profile to be activated, such as specific greetings for different times of the day, or to effect other fuctions such as call forwarding.

### TECHNICAL FIELD OF THE INVENTION

This invention relates to communication systems, in particular telephony systems and messaging options and methods for users of such systems.

### BACKGROUND OF THE INVENTION

Frequently, communications such as land based and cellular networks have communications service providers that offer voice messaging services. Alternatively, voice messaging services are provided as part of telephone systems in buildings or within firms, connected to PABXs.

Such voice messaging systems allow a call recipient to enter a voice messaging message with some additional parameters, for example the number of times the telephone will ring before the voice messaging message is delivered to the caller. Once the message has been delivered, the system usually provides more options such as the option to try another extension, such as the extension for a receptionist for example. Another option which is commonly employed is to have the system prompt the caller to leave a message which the system then records and makes it available to the intended call recipient when the recipient is subsequently available, or when the recipient prompts the system for delivery of any such messages.

In cellular networks and some landbased telephony networks, the network service provider will usually provide the service of a voice messaging mailbox. The intended call recipient is alerted of messages in the mailbox or of any missed calls and callers may leave messages in a fashion similar to that described above.

The disadvantage of these systems is that they have limited flexibility. In particular, with cellular networks, the primary purpose of a mobile telephone device is to allow the user greater flexibility. Thus, the user may be contacted or contact others at any number of locations remote from an office or desk. However, this advantage comes at the cost of the user being able to be contacted by any person at nearly any time. In addition present systems are very inflexible in their options for recording greetings and the high degree of impersonal call handling. This limits the intended additional flexibility of such systems,

### OBJECT OF THE INVENTION

It is an object of the present invention to provide an improved communication system or method which will at least go some way toward overcoming disadvantages associated with the prior art, or which will at least provide the public with a useful choice.

### SUMMARY OF THE INVENTION

The present invention provides users of communication networks, particularly cellular telephone networks with advanced voice messaging services and options. All these options and services are preferably provided within the voice messaging “engine” used by the cellular network. However, it will be appreciated that the services may be provided or interlinked in other ways within the communication network.

The invention provides voice messaging services in two general areas.

The first area is the ability to have caller specific greetings and options. Therefore, instead of callers hearing a generic voice messaging message from the intended call recipient, callers will instead hear a greeting specifically recorded for them based upon their CLI or ANI number. This greeting will generally be pre-recorded by the cellular phone's user either into the “voice messaging engine” or into the phone itself. In this document CLI represents. Calling Line Identification number and ANI represents the caller Automatic Number Identification.

In another area the system not only provides call specific greetings but also unique specific options available to different users. Therefore, one selected user may have the option of being forwarded to a further number, for example on a land line or mobile (i.e. cellular) phone where the intended call recipient is presently located, they may offer diversion to a pager service, an inhouse paging system or another caller may not have that option and may instead only have the option of leaving a voice message for example. Or even as a further option some callers may hear a message telling them not to call again and the call can then be terminated.

As an example, a caller with a number of 949-555-2121 has a Caller profile recorded for them by a specific Cellular User. When that caller calls from the 949-555-2121 number the voice messaging “engine” or the phone itself (with an inbuilt database and voice storage capability) matches that number (from its own database or from an integrated database) with the specific caller profile pre-recorded for that caller. E.g. “Hi Johnny, Fred here, I can't take your call right now but I do want to catch up with you, so please leave me a message after the tone” or the caller may hear “Hi Johnny, Fred here, I can't take your call right now but I do want to catch up with you, so please press 1 and you will go to my pager service and they will page me, or leave a message after the tone”. This profile invention is achieved by the matching of an ANI or CLI number to a pre-recorded greeting, the playing of that greeting to uniquely personalise the call, and then the ability for the caller, on a caller by caller basis to have further options to try to connect to the receiving cellular user.

In a further aspect the invention also provides one or more greeting profiles which may be created by an intended call recipient, the profiles being activated manually or automatically based upon predetermined parameters such as the time, day or time of day.

The profiles may comprise one or more greetings which are pre-recorded by the call recipient and are configured so as to the time or activity or possibly location specific. These profiles will typically be the days of the week, “gone for the day”, “weekend”. “On a conference call”, “in a meeting” etc. These greetings can be set to a schedule for say, the days of the week greetings (Hi, it is Fred and it is Monday and I haven't been able to take your call so please leave me a message and I will get back to you as soon as possible), night (Hi, it is Fred and I have left the office and I am unable to take your call right now so please leave me a message after the tone), gone for the weekend (Hi, it is Fred and it is the weekend and I haven't been able to take your call so please leave me a message after the tone and I will get back to you on Monday) etc. The announcement of these changing profiles creates the impression that the cellular user is changing their greetings on at least a daily basis and is therefore a responsive voice messaging user. Additionally the greetings that give the immediate message of unavailability (e.g. in a meeting greeting) give caller more and better information as to why they cannot reach their calling party.

Preferably the profiles also include commands, or commands are attached to the profiles. Therefore, if a user associates his or her specific greeting with a command such as a call forward command, then at least one identified caller will immediately be sent through a specific greeting rather than the intended recipient's telephone ringing. An example of this may be the “in a meeting greeting”, the cellular user is unavailable, so instead of their phone ringing the greeting will be immediately played as that specific profile has the call forward command activated, as opposed to the “Monday greeting” where the cellar user wants the phone to ring, and only if they do not answer will the specific Monday greeting be played to callers.

Greeting profiles can be activated manually as an alternative or over-ride to a schedule. These profiles can be selected via the cellular device, where the profile is selected on the phone and as selected this choice is communicated back to the “voice messaging engine” from the device and that specific profile is activated. Similarly when the schedule needs to be re-established this is also done from the cellular device as a choice.

Call profiles and greeting profiles can be inter-related, a greeting profile may be over-riden on a case by case basis if a caller profile is in place for a caller.

Recording and setup of caller and greeting profiles can be handled, either from a web based administrator that is working in parallel with the cellular user's phone (that is the profiles are being set up via the web based administrator and the actual recording is being done via the cellular phone mechanism) or the profiles can be set up from the cellular device itself by the user selecting and recording profiles directly into the “voice messaging engine”.

In a further aspect the invention consists in a call handling method including the steps of receiving an identifier associated with an incoming call, matching identifier with one of a plurality of predetermined identifiers, and implementing a profile associated with the identifier.

In a further aspect the invention consists in a communications system including means to receive an identifier associated with an incoming call, a memory to store a plurality of predetermined identifiers, means to match the received identifier with at least one of the predetermined identifiers, and means to implement a profile associated with the received identifier.

In another aspect the invention consists in a personal communications device including means to receive an identifier associated with an incoming call, a memory to store a plurality of predetermined identifiers, means to match the received identifier with at least one of the predetermined identifiers, and a means to implement a profile associated with the identifier.

In a further aspect the invention may broadly be said to consist in a telephone (including video phone or VoIP) communication system including

a memory means to record one or more identifiers to provide an identity for at least one proposed caller or user of the system,

means to receive and appropriately identify incoming calls and compare that identifier with the identifiers in the memory means to thereby identify the probable identity of the caller,

profile creation means for a user to create one or more profiles which may be selectively applicable to one or more potential callers,

processing means to process an identified incoming caller dependent on the applicable profile.

Preferably the profile includes instructions which provide a specific response to the caller.

Preferably the instructions include providing one or more selected voice messaging greetings to the caller.

Preferably the instructions include the step of providing the caller with the list of options for continuing with the call.

Preferably the instructions include providing the caller with the option of being directly connected to the intended call recipient.

The invention also broadly consists in any feature or features described in this document either alone or in combination.

### DRAWING DESCRIPTION

A preferred embodiment of the invention will now be described with reference to the following drawings. It will be understood that the preferred embodiment is one example only of putting the invention into effect and is not intended to limit the scope or spirit of the invention.

FIG. 1 is a part of a schematic diagram of a cellular communication system according to the present invention

FIG. 2 is a flow chart of a process for generating profiles according to the invention

FIG. 3 is a flow chart of a process flow path for choice by a user of various commands for attachment to profiles referred to in the flow chart of FIG. 2 according to the invention,

FIG. 4 is a flow chart showing a process flow for an incoming call processed according to the present invention, and

FIG. 5 is a screen shot of a user interface for creating or amending profiles according to the invention.

### DESCRIPTION OF PREFERRED EMBODIMENT

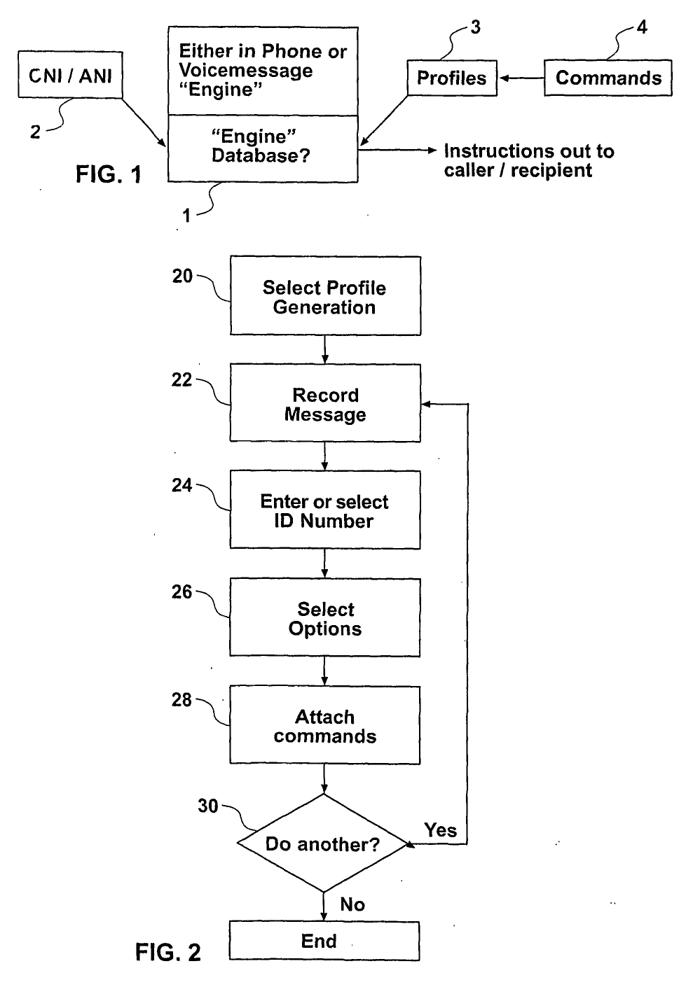

Referring to FIG. 1, an overall schematic showing general operation of the present invention is shown. A processor or “engine” having appropriate software for recording voice data, actioning various commands or instructions provided by users, and memory including a database for retaining software commands or instructions, files and the like for carrying out a process flow according to those instructions is provided. This is generally referenced 1 in FIG. 1, and may be provided in one physical location or at a number of distributed physical locations. Therefore, the apparatus 1 may be provided as part of a cellular communications network exchange, or as part of that exchange and provided on one or more individual mobile phones of users of such a system, or may be provided elsewhere but accessible by the network. For convenience the engine 1 is shown referenced as a single item. Furthermore, although the remaining features described below with reference to FIG. 1 are provided in separate boxes for purposes of illustration, it will be seen that these features may be implemented or included as a part of the engine 1. It will also be seen that many features may be provided in the user's communication device itself.

The invention includes means to identify incoming calls. This is shown in box 2. Therefore, when calls come in to box 2, the data associated with the call, which may be provided by another exchange, will usually comprise data for enabling caller number identification (CNI) or automatic number identification (ANI). This data is retrieved from a database and processed in box 2 to provide a means for identifying the source of the incoming call.

In box 3, a number of profiles are provided. Each profile may be tailored specifically for one particular caller (i.e. for one ANI or CNI identifier), or may be applicable to a group of potential callers or users of the systems. Each of the profiles will typically have a recorded greeting which the system may send to the caller and may optionally provide the caller with a number of “interactive” options which the caller may use to leave a message, or try an alternative number or alternative extension for example.

In box 4, user commands which may be attached to profiles are provided. The user commands are ones which are available to the system but which may be selected by a system user to be attached to the profiles so as to activate the profiles at desired times, locations, or on demand. Commands and/or profiles may be changed by a user remotely using any desired communication device, including a pager, cellular phone, POTs phone or on the internet. Therefore, a cellular phone user with 2-way pager or cellular technology can select or change a user profile on their landline, cellular, or other telephone.

Turning to FIG. 2, a short flow chart is illustrated to demonstrate generation of the profiles. Therefore, beginning at box 20, the user initialises profile generation. This step may occur by the user going to an appropriate menu on a cellular telephone for example. The menu may typically be under a special menu of the mobile phone, or may be under an existing menu such as the “phone book” type menu that is provided on many mobile phones. Or may be generated by the “voice messaging engine” that is accessed from the cell.

Alternatively, the appropriate instructions may be input from a keypad or a PDA device using a computer network such as the Internet for example. Alternatively the instructions may be appropriately recorded on a floppy disk or other medium which may be provided to the communications provider so that the data may be loaded into the exchange to effect the invention.

Once an appropriate menu has been selected for generating a profile, the user will typically begin by recording a message, for example a voice or text message, in step 22. The user then, in step 24, has the option of associating that profile with a number such as the telephone number (or more directly by the ANI or CNI information) of a potential caller. If no particular number is to be associated with the message, for example if the profile is one which is intended for all calls of unknown identity, then some other selected number or combination of numbers or numerals may be used. Similarly, certain numbers may be provided to select one or more groups of incoming calls, dependent on a certain property of the caller ID, for example work contacts or personal contacts.

A number of options may then be chosen as shown in box 26, these include the length of time for which the call recipient's phone may ring for a given profile before the message is delivered. Also, once the message is delivered, there may be options to enable the caller to pursue the call,

For example, an option may be provided to allow the caller to hit a digit on the keypad of his or her phone and have that act as an instruction to the exchange to transfer the call to another number. Alternatively, the call may be transferred automatically under another option to another available number. As described further below, these options may be dependent upon certain variables such as the time of day or location of the call recipient. Under existing cellular technology, the location of a cellular phone may be tracked, and dependent upon the general location, a call may be forwarded to the nearest office for example. However, these options will often need to be changed dependent upon the activities of the intended call recipient. Therefore, a further menu or selection process for user commands may be used to implement these.

Continuing with the description of the options in box 26 of FIG. 2, it will be seen that a very wide variety of options may be provided and that these may be implemented depending upon the profile that the call recipient wants to generate.

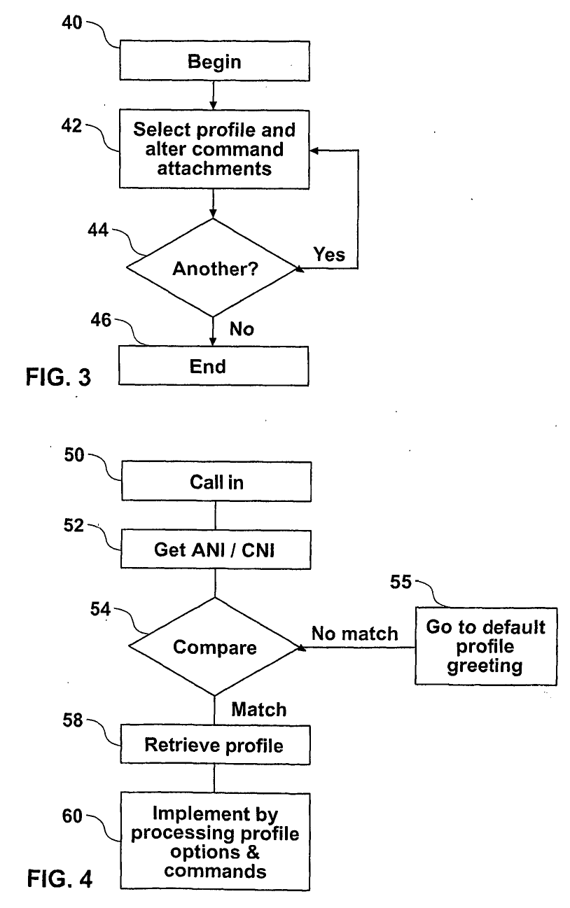

In box 28, a number of user commands may optionally be added at this point to the profile which has been generated. The command selection is also described in a separate flow chart under FIG. 3, as this may need to be changed independently of the general profile.

In box 30, a decision is provided for the user to either exit the profile generation menu, or to enter a further profile. If a further profile is required then the process begins again at step 22. Otherwise, the process finishes at box 32.

Turning now to FIG. 3, the command selection process begins at box 40 by a user selecting the appropriate menu. Again, this may be generated using the call recipient's mobile phone or PDA, or in other ways such as described above including use of the Internet. The caller then accesses various commands that are available in step 42 and enters the required parameters associated with the location of the call recipient, or activities of the call recipient at that particular time. Therefore, for example a blanket command may be issued that the specific greeting which has been recorded for known identified incoming calls is provided to each known caller, but the caller is not provided with any further options other than to leave a message. This command may also be issued for non-identified incoming calls.

Furthermore, more specific commands may be entered to either activate or deactivate various options. Therefore for example, if the user wishes to take calls during one or two hours of the day at a selected time then this may be entered as a command so that the option for a caller to have the call diverted to a number where the user will be for those selected hours will only be actioned at that particular time. Otherwise, that option will not be available. It will be seen that a wide variety of options may be implemented and that they may be generated for individual profiles, or selected group of profiles, or all profiles.

Once a profile has been selected to attach various commands to that profile, the user then is offered the option of altering commands attaching to further profile(s) in step 44, or quitting the menu in step 46.

Turning now to FIG. 4, the overall process is described. Firstly, an incoming call is represented in box 50. The appropriate identifier for the call is selected for processing in step 52. This enables some reasonable identification of the source of the incoming call i.e. the person “behind” the call to be realised. In step 54 a comparison is made with the identification information from the incoming call with the available data for the call recipient. This data is that data which is provided by the call recipient to the communications system. If there is no match, then the appropriate profile (if any) is selected by the system in step 56. If there is a match, then the appropriate profile selected in step 58 and the options associated with that profile and the commands attached to that profile are processed to arrive at an appropriate set of instructions. These instructions are then implemented in step 60 by the communications network. As described above, such a limitation may typically result in a personalised greeting to the identified caller and then further options being provided to the caller for pursuing the call dependent upon the commands provided which may relate to the time of day, for example.

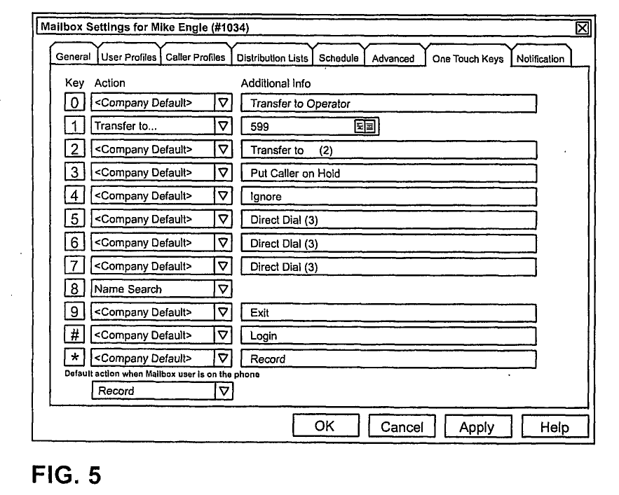

Turning now to FIG. 5, an example of an interface which may be used to create, manage or alter the profiles described above is shown. The interface is shown in a suitable graphical environment such as the “windows” environment for example. As can be seen, a column of keys that can be used to implement various features or commands and thus assist in creating profiles, such as a specific profile for each caller, or a profile for a user is shown. Next to each key is an appropriate action. The actions may be listed as certain default actions for each key, or specific selected actions. Thus key 1 corresponds to transferring the call to a particular extension. These keys may be provided as options for the caller in the caller's profile. The keys may also be used in the creation of caller profiles, for example the caller profile may be set up so that at a particular time of the day calls from that particular caller are always transferred to a certain extension.

The invention provides the advantage that greater flexibility is provided to the user of the mobile phone in terms of most efficiently using time by having those callers for whom various matters need to be resolved or actioned quickly being effectively given priority while retaining information from other calls so that communication can still be achieved, albeit at a later time.

The system also provides the full usage of the capabilities of a mobile telephony system in that call diversions can automatically be made to various places dependent upon parameters such as time of day or location of the actual mobile phones.

Finally, it will be appreciated that although the invention is being described with reference to a preferred embodiment, changes in technology and various other data formats, software and methods of implementation may be used without departing from the scope of the invention.

1. A call handling method including the steps of:
receiving an identifier associated with an incoming call, matching the identifier with one of a plurality of predetermined identifiers, and implementing a profile associated with the identifier.

2. A method as claimed 1 wherein the step of implementing the profile includes the step of selecting a message for delivery to the caller from a plurality of pre-recorded messages.

3. A method as claimed in claim 1 wherein the step of implementing the profile includes the step of passing the call to the intended recipient or providing a pre-recorded message to the caller.

4. A method as claimed in claim 1 wherein the step of implementing the profile includes the step of providing the caller with an option for communicating with the intended call recipient.

5. A method as claimed in claim 4 wherein the step of implementing the profile includes the step of providing the caller with the option of recording a message for the intended caller recipient, or of taking a further step to contact the intended caller recipient.

6. A method as claimed in claim 4 wherein the further step includes one or more of diverting the call or paging the intended caller recipient, leaving a text message for the recipient, leaving a voice message for the recipient, leaving an audiovisual message for the recipient.

7. A method as claimed in claim 1 wherein implementation of the profile is dependent on the time at which the call is received.

8. A method as claimed in claim 1 wherein the implementation of the profile is dependent on the location of the intended call recipient.

9. A communication system programmed and operable to effect the method of claim 1.

10. A personal communications device programmed and operable to effect the method of claim 1.

11. (Canceled).
